(19) United States
(12) Patent Application Publication
(10) Pub. No.: US 2026/0238954 A1
(43) Pub. Date: Aug. 13, 2026

(54) EMULATING A LARGER VIRTUAL PLAYBACK ROOM WITHIN A SMALLER REAL-WORLD PLAYBACK ROOM FOR AUDIO PLAYBACK

(71) Applicant: HOLOPLOT GMBH, Berlin (DE)

(72) Inventor: Helmut OELLERS, Berlin (DE)

(73) Assignee: HOLOPLOT GMBH, Berlin (DE)

(21) Appl. No.: 19/051,916

(22) Filed: Feb. 12, 2025

(51) Int. Cl. H04S 7/00; G06F 3/16; H04R 5/02

(52) U.S. Cl. CPC H04S 7/305; G06F 3/165; H04R 5/02; H04S 7/303; H04S 2400/11

(57) ABSTRACT

Systems, methods, and apparatuses can playback audio content within a real-world playback room. These systems, methods, and apparatuses can tailor the audio content to create an auditory illusion making it seem that the real-world playback room is different than its actual physical dimensions. These systems, methods, and apparatuses can beneficially generate one or more direct sound wave fronts of the audio content that directly reach an audience within the real-world playback room and/or one or more indirect sound wave fronts that indirectly reach the audience, for example, after being reflected by one or more surfaces, for example, walls, ceilings, floors, furniture, or other objects within the real-world playback room before reaching the audience. These systems, methods, and apparatuses can advantageously customize the one or more indirect sound wave fronts to create the impression that the audience is in a different physical space than the real-world playback room. These systems, methods, and apparatuses can customize the time differences and/or level difference between these direct sound wave fronts and/or these indirect sound wave fronts to create the impression that the audience is physically present in a different virtual playback room rather than the real-world playback room.

### BACKGROUND

The acoustic properties of a small room, such as a living room or a small home theater, have a significant influence on reproducing sound within the small room. However, these acoustic properties generally do not significantly influence direct sound wave fronts that reach an audience within the small room without encountering any reflective surfaces of the small room. On contrary, these acoustic properties can significantly influence indirect sound wave fronts that reach the audience after reflecting off reflective surfaces, such as walls, ceilings, floors, or furnishings. These indirect sound wave fronts can be crucial for the subjective perception of the sound reproduced within the small room. These reflections can include early reflections, late reflections, or reverberation. Early reflections represent the initial bounces of the sound reproduced that arrive the audience shortly after the direct sound wave fronts, for example, within the fifty (50) milliseconds (ms) after the arrival of these direct sound wave fronts. These early reflections can enhance the perceived loudness of the sound without significantly diminishing clarity. Late reflections arise from multiple successive bounces, contributing to a reverberant sound field that can add spatial depth but, if excessive, can impair sound intelligibility and introduce auditory muddiness.

The behavior of sound wave fronts within the small room can be heavily influenced by its physical characteristics. Hard, reflective surfaces, such as glass or concrete, tend to amplify indirect sound wave fronts, increasing the likelihood of echoes and excessive reverberation. Conversely, absorptive materials such as acoustic panels, curtains, and carpets can attenuate these reflections, resulting in improved clarity and a more controlled acoustic environment. Diffusion, or the scattering of sound wave fronts when they interact with irregular or specially designed surfaces, plays a critical role in mitigating focused reflections and distributing sound energy more evenly across the small room. Achieving optimal sound quality in the small room necessitates a careful balance between direct and indirect sound wave fronts. Conventionally, this balance can be accomplished through strategic deployment of absorptive materials to control excessive reflections, the use of diffusion panels to scatter sound wave fronts and create a more uniform sound field, and the precise placement of sound sources to balance the direct and indirect sound wave fronts.

### BRIEF DESCRIPTION OF THE DRAWINGS

The present disclosure is described with reference to the accompanying drawings. In the drawings, reference numbers indicate identical or functionally similar elements. Additionally, the left most digit(s) of a reference number identifies the drawing in which the reference number first appears. In the accompanying drawings:

FIG. 1 illustrates a simplified block diagram of an exemplary playback environment according to some exemplary embodiments of the present disclosure;

FIG. 2 illustrates an exemplary direct soundwave that can originate within the exemplary playback environment according to some exemplary embodiments of the present disclosure;

FIG. 3 illustrates exemplary one or more indirect sound wave fronts that can be generated within the exemplary playback environment according to some exemplary embodiments of the present disclosure;

FIG. 4 further illustrates the exemplary one or more indirect sound wave fronts that can be generated within the exemplary playback environment according to some exemplary embodiments of the present disclosure;

FIG. 5 illustrates an exemplary operational control flow for playing back audiovisual content within the exemplary playback environment according to some exemplary embodiments of the present disclosure;

FIG. 6 illustrates a simplified block diagram of an exemplary playback room controller that can be implemented within the exemplary playback environment according to some exemplary embodiments of the present disclosure; and

FIG. 7 illustrates a simplified block diagram of an exemplary computer system that can be implemented within the exemplary playback environment according to some exemplary embodiments of the present disclosure.

The present disclosure will now be described with reference to the accompanying drawings.

### DETAILED DESCRIPTION

The following disclosure provides many different embodiments, or examples, for implementing different features of the provided subject matter. Specific examples of components and arrangements are described herein to simplify the present disclosure. These are, of course, merely examples and are not intended to be limiting. Aspects of the present disclosure are best understood from the following detailed description when read with the accompanying figures. The present disclosure may repeat reference numerals and/or letters in the various examples. This repetition does not in itself dictate a relationship between the various embodiments and/or configurations discussed. It is noted that, in accordance with the standard practice in the industry, features are not drawn to scale. In fact, the dimensions of the features may be arbitrarily increased or reduced for clarity of discussion. The following disclosure may include the terms “about” or “substantially” to indicate the value of a given quantity can vary based on a particular technology. Based on the technology, the term “about” or “substantially” can indicate a value of a given quantity that varies within, for example, 1-15% of the value (e.g., ±1%, ±2%, ±5%, ±10%, or ±15% of the value).

### Overview

Systems, methods, and apparatuses can playback audio content within a real-world playback room. These systems, methods, and apparatuses can tailor the audio content to create an auditory illusion making it seem that the real-world playback room is different than its actual physical dimensions. These systems, methods, and apparatuses can beneficially generate one or more direct sound wave fronts of the audio content that directly reach an audience within the real-world playback room and/or one or more indirect sound wave fronts that indirectly reach the audience, for example, after being reflected by one or more surfaces, for example, walls, ceilings, floors, furniture, or other objects within the real-world playback room before reaching the audience. These systems, methods, and apparatuses can advantageously customize the one or more indirect sound wave fronts to create the impression that the audience is in a different physical space than the real-world playback room. These systems, methods, and apparatuses can customize the Time Difference and/or Level Difference between these direct sound wave fronts and/or these indirect sound wave fronts to create the impression that the audience is physically present in a different virtual playback room rather than the real-world playback room.

### Wave Field Synthesis (WFS)

Before describing these systems, methods, and apparatuses in further detail, wave field synthesis (WFS) is to be generally discussed. The WFS can be used to precisely control the direction, shape, and placement of various sound wave fronts in a three-dimensional space, for example, a real-world playback room described herein, to create immersive audio experiences. Generally, the WFS represents a spatial audio rendering technique that allows sound fields to be created and controlled with precision. Unlike conventional stereo or surround sound systems which rely on discrete speaker placements in the three-dimensional space to simulate spatial sound, exemplary loudspeaker arrays described herein can create sound wave fronts that seem to originate from virtual sound sources in the three-dimensional space. These exemplary loudspeaker arrays can simultaneously generate multiple sound wave fronts having precisely controlled phases and/or amplitudes. These precisely controlled phases and/or amplitudes can advantageously control how these sound wave fronts combine, shaping the direction, focus, and spread of these sound wave fronts in the three-dimensional space to effectively generate sound wave fronts that appear to originate from these virtual sound sources. The exemplary loudspeaker arrays described herein can simulate sound sources that appear to emanate from specific locations in the three-dimensional space regardless of the listener's position. These loudspeaker arrays can deliver sound to targeted areas or listeners within the three-dimensional space with minimal interface or unwanted sound dispersion. The exemplary loudspeaker arrays described herein can further control the phase and/or the amplitudes of the soundwaves provided by each loudspeaker to create narrow or wide beams of sound that are aimed at specific locations with the three-dimensional space to provide unprecedented control over sound placement. These loudspeaker arrays can generate focused beams of sound that can be directed to specific listening zones, while beneficially minimizing interference and/or reflections in unwanted areas. And the exemplary loudspeaker arrays described herein can precisely control the shape and the intensity of the sound wave fronts at these specific listening zones independently of one another.

### EXEMPLARY PLAYBACK ENVIRONMENT

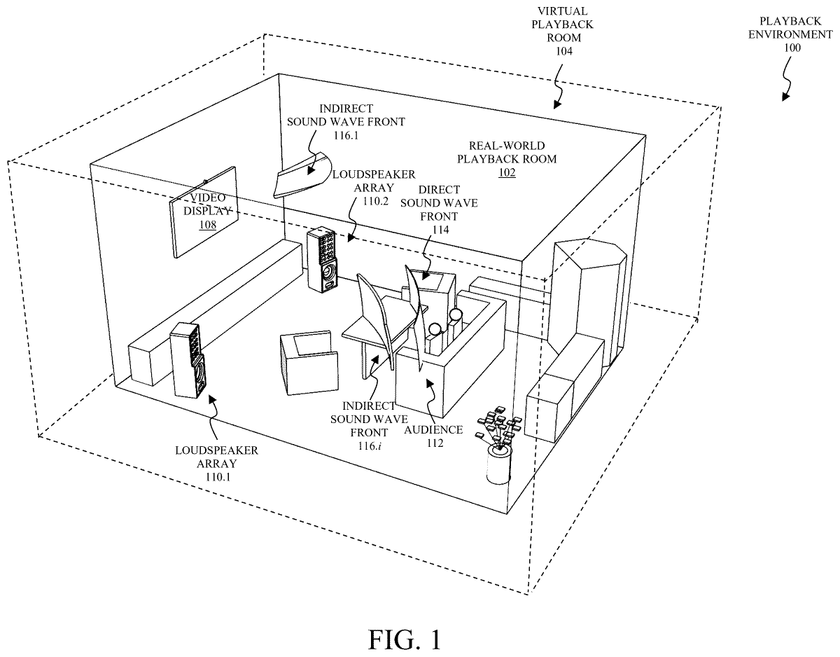

FIG. 1 illustrates a simplified block diagram of an exemplary playback environment according to some exemplary embodiments of the present disclosure. In the exemplary embodiment illustrated in FIG. 1, a playback environment 100 can enhance the sensory perception of the physical space of a real-world playback room while playing back audiovisual content. In some embodiments, the playback environment 100 can tailor the audiovisual content to create an auditory illusion creating an impression that the real-world playback room is different, for example, larger or smaller, than its actual physical dimensions. In these embodiments, the playback environment 100 can beneficially generate one or more direct sound wave fronts of the audiovisual content that directly reach the audience and/or one or more indirect sound wave fronts of the audiovisual content that reflect, or bounce, off one or more surfaces of the real-world playback room before reaching the audience. In these embodiments, the playback environment 100 can advantageously customize these one or more indirect sound wave fronts to create the impression that the audience is in a different physical space than the real-world playback room. As illustrated in FIG. 1, the playback environment 100 can include a real-world playback room 102 and a virtual playback room 104.

In the exemplary embodiment illustrated in FIG. 1, the playback environment 100 can effectively customize the audiovisual content to create an auditory illusion creating the impression that the audible content is being played in the virtual playback room 104 that is physically larger than the real-world playback room 102. In some embodiments, the real-world playback room 102 may be referred to as a “small” room. In these embodiments, the “small” room may be referred to as being a space, a chamber, an area, a suite, a zone, an enclosure, a place, or the like where the first reflections reach the center, or near center, of this space, chamber, area, suite, zone, enclosure, place, or the like in less than approximately fifteen (15) milliseconds (ms), which corresponds to a sound detour round about five (5) meters, or less, in relation to a direct sound wave front 114 as illustrated in FIG. 1. In some embodiments, this “small room” can include home theaters, cinema halls, virtual reality rooms, a smart home automation, and/or or an immersive entertainment setup, among others. Otherwise, if these first reflections that reach the center, or near center, of the space, chamber, area, suite, zone, enclosure, place, or the like in more than approximately fifteen (15) milliseconds (ms) after the direct sound wave front 114, the real-world playback room 102 may be considered a “large” room. As illustrated in FIG. 1, the real-world playback room 102 can include a video display 108, and loudspeaker arrays 110.1 and 110.2. Although the real-world playback room 102 is described herein as including the video display 108 and the loudspeaker arrays 110.1 and 110.2 in FIG. 1, this is for exemplary purposes only and not limiting. Rather, those skilled in the relevant art(s) will recognize that the real-world playback room 102 can include any suitable number of video displays, and/or loudspeaker arrays without departing from the spirit and scope of the present disclosure.

The video display 108 can playback the visual content, such as images, videos, animations, and other visual elements, to an audience 112 within the real-world playback room 102 in a clear, immersive, and/or high-quality manner. In some embodiments, the video display 108 can be high-definition (HD) or ultra-high-definition (UHD), offering enhanced resolution for sharper and more detailed visual content. In these embodiments, the video display 108 can be implemented using various technologies, such as liquid crystal displays (LCDs), light providing diodes (LEDs), organic LEDs (OLEDs), quantum dot LEDs (QLEDs), plasma displays, active-matrix OLEDs, curved displays, and/or touchscreens, among others. In the exemplary embodiment illustrated in FIG. 1, the video display 108 often works in tandem with the loudspeaker arrays 110.1 and 110.2 to create a cohesive sensory experience for the playback of the audiovisual content in the real-world playback room 102 as described herein.

The loudspeaker arrays 110.1 and 110.2 can play back the audio content, such as sound effects, dialogue, music, and other audio elements, to the audience 112 in a clear, immersive, and/or high-quality manner. In some embodiments, the loudspeaker arrays 110.1 and 110.2 can be configured and arranged to create a phantom loudspeaker within the playback environment 100. In these embodiments, the phantom loudspeaker represents a perceived sound source that appears to originate from a specific location within the playback environment, even though the loudspeaker arrays 110.1 and 110.2 are not physically present at that location. For example, when the loudspeaker arrays 110.1 and 110.2 provide identical direct sound wave fronts, the audience 112 perceives these direct sound wave fronts as being provided from a phantom loudspeaker situated directly between the loudspeaker arrays 110.1 and 110.2. In these examples, the perceived location of the phantom loudspeaker can be moved between the loudspeaker arrays 110.1 and 110.2 by varying the one or more direct sound wave fronts. In the exemplary embodiment illustrated in FIG. 1, the loudspeaker array 110.1 operates in a substantially similar manner as the loudspeaker array 110.2. As such, only loudspeaker array 110.1 will be described in more detail below. Generally, the loudspeaker array 110.1 can provide sound wave fronts that carry the audio content that travel through the playback room 102 to reach the audience 112. As illustrated in FIG. 1, the loudspeaker array 110.1 can provide the direct sound wave front 114 and one or more indirect sound wave fronts 116.1 through 116.i. In some embodiments, the direct sound wave front 114 and the one or more indirect sound wave fronts 116.1 through 116.i can contribute to the auditory experience within the real-world playback room 102. As illustrated in FIG. 1, the direct sound wave front 114 represents the sound wave front that travels directly from the loudspeaker array 110.1 to the audience 112 without any interference or reflection with the real-world playback room 102. In some embodiments, the direct sound wave front 114 travels along a straight, or nearly straight, pathway from the loudspeaker array 110.1 to the audience 112, typically unaltered by obstacles or surfaces in the real-world playback room 102.

As illustrated in FIG. 1, the one or more indirect sound wave fronts 116.1 through 116.i represent sound wave fronts that travel from the loudspeaker array 110.1 to the audience 112 after being reflected by one or more surfaces, for example, walls, ceilings, floors, furniture, or other objects within the real-world playback room 102. In some embodiments, the one or more indirect sound wave fronts 116.1 through 116.i can provide auditory cues to the audience 112 about the size, the shape, and/or the acoustics, among others, of the real-world playback room 102. In these embodiments, the loudspeaker array 110.1 can advantageously customize the one or more indirect sound wave fronts 116.1 through 116.i to create the impression that the audience 112 is in the larger virtual playback room 104 rather than the smaller real-world playback room 102. In some embodiments, larger rooms, such as the virtual playback room 104, with better acoustics can provide a more emotionally engaging performance. In these embodiments, the virtual playback room 104 can offer better sound clarity, more controllable reverberation and a richer, more natural listening experience and, among others, a richer, more natural listening experience when compared to the real-world playback room 102. In some embodiments, the real-world playback room 102 often lacks the physical space to allow sound to develop fully, often leading to muddier, distorted, or unbalanced sound when compared to the virtual playback room 104. In some embodiments, the loudspeaker array 110 can cause the one or more indirect sound wave fronts 116.1 through 116.i to appear to be reflected by one or more surfaces, for example, walls, ceilings, floors, furniture, or other objects within the virtual playback room 104 to create the impression that the audience 112 is in the larger virtual playback room 104 rather than the smaller real-world playback room 102.

In some embodiments, the acoustic properties of the virtual playback room 104 can be adapted to the content of the audio playback. In these embodiments, these acoustic properties can determine how the indirect sound wave fronts 116.1 through 116.i are reflected, absorbed, diffused, and/or transmitted, among others, within the virtual playback room 104, impacting the quality and clarity of sound in the room. In some embodiments, these acoustic properties can include, or be related to, reverberation time, sound absorption, sound reflections, diffusion, absorption coefficient, bass response, room modes, sound isolation, and/or sound transmission loss, among other. In these embodiments, these acoustic properties can be manipulated to optimize the virtual playback room 104 for various purposes, for example, improving speech intelligibility, enhancing music sound, and/or minimizing noise, among others. For example, the virtual playback room 104 can emulate a relatively small, heavily damped virtual studio for a newsreader. The speech intelligibility is significantly higher than it would be with the barely directional sound radiation of conventional loudspeakers, because of the orientation of the direct sound wave front 114. Fewer first reflections of the playback room arise, which in turn are the sound source for its higher-order reflections, for example, the reverberation. In this example, the high proportion of reverberation reduces the speech intelligibility in an acoustically untreated reproduction rooms. In another example, the virtual playback room 104 can emulate a more reflective virtual studio for a large concert in a hall in which the early strong reflections arrive at the audience 112 in a detour between about five (5) meters and seventeen (17) meters after the direct sound wave front 114. In some embodiments, these acoustic properties of the virtual playback room 104 can be selected by a user, by metadata embedded within the audiovisual content, and/or Machine Learning (ML), Artificial Intelligence (AI), Neural Networks, Deep Learning (DL), Reinforcement Learning (RL), and/or Speech Recognition, among others.

Exemplary Direct Sound Wave Fronts that can be Generated within the Exemplary Playback Environment

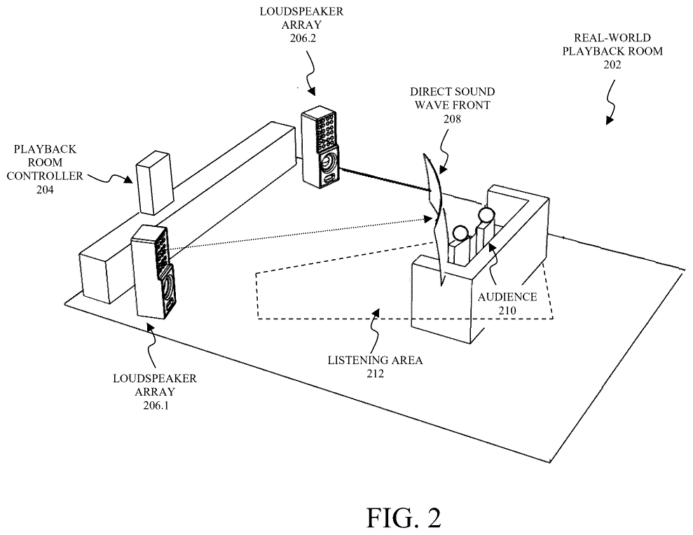

FIG. 2 illustrates an exemplary direct soundwave that can originate within the exemplary playback environment according to some exemplary embodiments of the present disclosure. In the exemplary embodiment illustrated in FIG. 2, a real-world playback room 202 can beneficially generate one or more direct sound wave fronts that are associated with the audio content that directly reach the audience, for example, along a line. In some embodiments, the real-world playback room 202 can precisely control these direct sound wave fronts within the real-world playback room 202 to create highly localized and customizable listening areas within the real-world playback room 202. In these embodiments, the real-world playback room 202 can precisely control these direct sound wave fronts to prevent these direct sound wave fronts from undesirably interacting with the real-world playback room 202, for example, reflecting and/or refracting. For example, the directional radiation of these direct sound wave front can prevent the original reflections of these direct sound wave fronts from the real-world playback room 202 from overlapping with the these direct sound wave front to avoid, for example, double spatialization. As illustrated in FIG. 2, the real-world playback room 202 can include a playback room controller 204 and loudspeakers array 206.1 and 206.2. Although the real-world playback room 202 is described herein as including the loudspeaker arrays 206.1 and 206.2 in FIG. 2, this is for exemplary purposes only and not limiting. Rather, those skilled in the relevant art(s) will recognize that the real-world playback room 202 can include any suitable number of loudspeaker arrays to generate any suitable number of direct sound wave fronts without departing from the spirit and scope of the present disclosure. In some embodiments, the real-world playback room 202 can represent an exemplary embodiment of the real-world playback room 102. In these embodiments, the loudspeaker arrays 206.1 and 206.2 can represent exemplary embodiments of the loudspeaker arrays 110.1 and 110.2 as described herein.

As illustrated in FIG. 2, the playback room controller 204 represents a centralized device, or part of a centralized system, that is responsible for managing the playback of audiovisual content within the real-world playback room 202. In some embodiments, the playback room controller 204 coordinates both visual and audio content, ensures the correct video and audio elements are paired, synchronized, and/or played back in the real-world playback room 202, and/or contributes to the overall experience in the real-world playback room 202. In these embodiments, the playback room controller 204 can ensure that the audio and video elements are synchronized, maintaining the timing and cohesion between the visual and audio content. In some embodiments, the playback room controller 204 can identify the visual content, such as images, videos, animations, and other visual elements, and/or the audio content, such as sound effects, dialogue, music, and other audio elements, that is part of the audiovisual content being played back in the real-world playback room 202. In some embodiments, the playback room controller 204 can provide the visual content to a video display, such as the video display 108, and/or the audio content to the loudspeaker arrays 206.1 and 206.2 to ensure a seamless playback of the audiovisual content within the real-world playback room 202. In some embodiments, the playback room controller 204 can be implemented as a standalone computing device or integrated into another host device, such as a loudspeaker array, an audio-video (AV) receiver, a smartphone, a tablet, a laptop, a home automation system, for example, a voice assistant, a smart television, or a streaming device, among others.

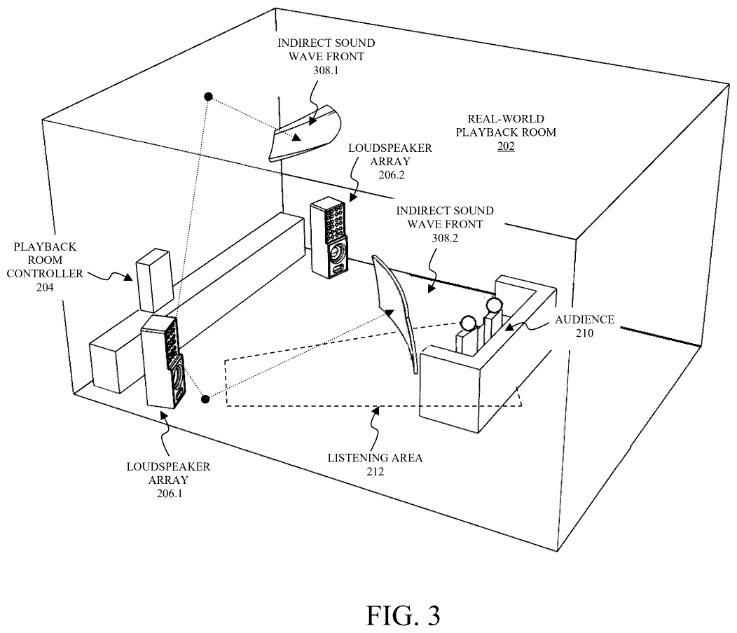

The loudspeaker arrays 206.1 and 206.2 can play back the audio content, such as sound effects, dialogue, music, and other audio elements, to one or more members of an audience 210 in a clear, immersive, and/or high-quality manner. In the exemplary embodiment illustrated in FIG. 2, and as described herein in FIG. 3 below, the loudspeaker array 206.1 operates in a substantially similar manner as the loudspeaker array 206.2. Therefore, only the loudspeaker array 206.1 will be described in more detail below. In some embodiments, the playback room controller 204 can generate precisely controlled a direct sound wave front 208 to be provided by the loudspeaker array 206.1 within the real-world playback room 202. In these embodiments, the playback room controller 204 can generate the direct sound wave front 208 that travels along a line to the audience 210 without undesirably interacting with the real-world playback room 202, for example, reflecting and/or refracting. However, some interaction between the real-world playback room 202 and the direct sound wave front 208 may be possible, for example, when the audience 210 is located approximately to one or more regions within the real-world playback room 202, for example, approximate to one or more surfaces, such as walls, ceilings, floors, furniture, or other objects within the real-world playback room 102.

In the exemplary embodiment illustrated in FIG. 2, the playback room controller 204 and/or the loudspeaker array 206.1 can shape the direct sound wave front 208. In some embodiments, the playback room controller 204 and/or the loudspeaker array 206.1 can shape the direct sound wave front 208 in accordance with the wave field synthesis (WFS) capabilities described herein. As part of these capabilities, the playback room controller 204 and/or the loudspeaker array 206.1 can determine one or more locations of one or more virtual sources to provide the direct sound wave front 208 within the real-world playback room 202. In some embodiments, the playback room controller 204 and/or the loudspeaker array 206.1 can determine wavefronts that would be generated by these virtual sources to provide the direct sound wave front 208 within the real-world playback room 202. In these embodiments, the playback room controller 204 and/or the loudspeaker array 206.1 can calculate the sound waves that needed to emitted by the loudspeaker array 206.1 to provide the direct sound wave front 208 within the real-world playback room 202. In some embodiments, the playback room controller 204 and/or the loudspeaker array 206.1 can estimate one or more parameters, characteristics, and/or attributes for these sound waves, for example, phases and/or amplitudes, to create the direct sound wave front 208 within the real-world playback room 202. In these embodiments, the playback room controller 204 and/or the loudspeaker array 206.1 can shape these sound waves in accordance with these parameters, characteristics, and/or attributes to provide the direct sound wave front 208. In some embodiments, the playback room controller 204 and/or the loudspeaker array 206.1 can shape these soundwaves to provide the direct sound wave front 208 to travel along a straight, or nearly straight, pathway from the loudspeaker array 206.1 to the audience 210 that minimizes interacting with the real-world playback room 202, for example, reflecting and/or refracting.

In some embodiments, the playback room controller 204 and/or the loudspeaker array 206.1 can shape the direct sound wave front 208 to can create a highly localized and customizable listening area 212 within the real-world playback room 202. In these embodiments, the playback room controller 204 and/or the loudspeaker array 206.1 can shape the direct sound wave front 208 to be perceived, namely, heard, by the audience 210 within the listening area 212. Although the playback room controller 204 and/or the loudspeaker array 206.1 are illustrated as creating the listening area 212 in FIG. 2, those skilled in the relevant art(s) will recognize that this loudspeaker array can create any suitable number of listening areas, for example, one or more listening areas, without departing from the spirit and scope of the present disclosure. For example, those skilled in the relevant art(s) will recognize that the loudspeaker array 206.1 can effectively split, or separate, the direct sound wave front 208 to provide any suitable number of excerpts of the direct sound wave front 208 to any suitable number of listening areas without departing from the spirit and scope of the present disclosure. Although the listening area 212 is illustrated as being trapezoidal in shape in FIG. 2, this is for illustrative purposes only and not limiting. Rather, those skilled in the relevant arts will recognize that the listening area 212 can be any suitable shape, such as a circle, a triangle, a square, a rectangle, a pentagon, a quadrilateral, a hexagon, or an octagon, among others, to provide some examples, or any suitable combination of suitable shapes without departing from the spirit and scope of the present disclosure.

Exemplary One or More Indirect Sound Wave Fronts that can be Generated within the Exemplary Playback Environment

FIG. 3 illustrates exemplary one or more indirect sound wave fronts that can be generated within the exemplary playback environment according to some exemplary embodiments of the present disclosure. In the exemplary embodiment illustrated in FIG. 3, the real-world playback room 202 can additionally, or further, generate one or more indirect sound wave fronts that indirectly reach the audience, for example, after being reflected by one or more surfaces, for example, walls, ceilings, floors, furniture, or other objects within the real-world playback room 202. In some embodiments, the real-world playback room 202 can precisely control these indirect sound wave fronts to create highly localized and customizable listening areas within the real-world playback room 202. In these embodiments, the real-world playback room 202 can precisely control these one or more indirect sound wave fronts to provide auditory cues to about the size, the shape, and/or the acoustics, among others, of the real-world playback room 202.

In the exemplary embodiment illustrated in FIG. 3, the playback room controller 204 and/or the loudspeaker array 206.1 can additionally, or further, generate precisely controlled one or more indirect sound wave fronts 308.1 and 308.2 to be provided by the loudspeaker array 206.1 within the real-world playback room 202. As illustrated in FIG. 3, the one or more indirect sound wave fronts 308.1 and 308.2 represent sound wave fronts that indirectly reach the audience 210 after being reflected by one or more surfaces, for example, walls, ceilings, floors, furniture, or other objects within the real-world playback room 202. In some embodiments, the playback room controller 204 and/or the loudspeaker array 206.1 can shape the one or more indirect sound wave fronts 308.1 and 308.2 in accordance with the wave field synthesis (WFS) capabilities described herein. In these embodiments, the playback room controller 204 and/or the loudspeaker array 206.1 can shape the one or more indirect sound wave fronts 308.1 and 308.2 to be provided by the loudspeaker array 206.1 to the listening area 212 as described herein. Although the loudspeaker array 206.1 is illustrated as providing the one or more indirect sound wave fronts 308.1 and 308.2 in FIG. 3, those skilled in the relevant art(s) will recognize that the loudspeaker array 206.1 can provide any suitable number of one or more indirect sound wave fronts that reflect off any suitable surfaces, for example, walls, ceilings, floors, furniture, or other objects within the real-world playback room 202, without departing from the spirit and scope of the present disclosure.

In the exemplary embodiment illustrated in FIG. 3, the one or more indirect sound wave fronts 308.1 and 308.2 provide auditory cues to the audience 210 about the size, shape, and/or acoustics, among others, of the real-world playback room 202. In some embodiments, the timing, the intensity, and/or the direction, among others, of the one or more indirect sound wave fronts 308.1 and 308.2 can, for example, in relation to the direct sound wave front 208, advantageously allow the audience 210 to perceive characteristics, for example, objects, boundaries, and/or the overall size, among others, of the real-world playback room 202. In these embodiments, a time difference and/or a level difference between to the direct sound wave front 208 and the one or more indirect sound wave fronts 308.1 and 308.2 can beneficially provide auditory cues to the audience 210 to assist them to perceive characteristics of the real-world playback room 202. Generally, the time difference is related to a difference between arrival times of the direct sound wave front 208 and the one or more indirect sound wave fronts 308.1 and 308.2 reaching the audience 210. In some embodiments, the time difference can be expressed as:

$$Δ t = \frac{{d}_{i n d i r e c t} - {d}_{d i r e c t}}{Speed of Sound} , \qquad ( 1 )$$

where d_{indirect} represents the distance of the pathway of one of the one or more indirect sound wave fronts 308.1 and 308.2 from the loudspeaker array 206.1 to the audience 210 in meters, d_{direct} represents the distance of the pathway of the direct sound wave front 208 from the loudspeaker array 206.1 to the audience 210 in meters, and the speed of sound is approximately 343 meters per second (m/s) around 20° C. but can vary. Generally, the level difference is related to a difference between intensities, or amplitudes, of the direct sound wave front 208 and the one or more indirect sound wave fronts 308.1 and 308.2 reaching the audience 210. In some embodiments, the level difference can be expressed as:

$$Level Difference ( db ) = 10 \times {log}_{10} ( \frac{{I}_{i n d i r e c t}}{{I}_{d i r e c t}} ) , \qquad ( 2 )$$

where I_{indirect} represents the intensity of one of the one or more indirect sound wave fronts 308.1 and 308.2, I_{direct} represents the intensity of the direct sound wave front 208, and the speed of sound is approximately 343 meters per second (m/s) around 20° C. but can vary.

For example, in the “small” room described herein, the one or more indirect sound wave fronts 308.1 and 308.2 may arrive quickly and at a similar intensity to the direct sound wave front 208. As another example, in the “large” room described herein, the one or more indirect sound wave fronts 308.1 and 308.2 may have longer delays and different intensities. In some embodiments, the playback room controller 204 and/or the loudspeaker array 206.1 can customize the time difference and/or the level difference between the direct sound wave front 208 and the one or more indirect sound wave fronts 308.1 and 308.2 to create the impression that the audience 210 is in a larger virtual playback room, such as the larger virtual playback room 104 to provide an example, rather than the smaller real-world playback room 202. In these embodiments, the temporal gap and/or the level gap between the direct sound wave front 208 and the one or more indirect sound wave fronts 308.1 and 308.2 can be artificially increased to create the impression that the audience 210 is in the larger virtual playback room rather than the smaller real-world playback room 202. Alternatively, or in addition to, the temporal gap and/or the level gap between the direct sound wave front 208 and the one or more indirect sound wave fronts 308.1 and 308.2 can be artificially decreased to create the impression that the audience 210 is in a smaller virtual playback room rather than the smaller real-world playback room 202.

In some embodiments, the playback room controller 204 and/or the loudspeaker array 206.1 can shape the one or more indirect sound wave fronts 308.1 and 308.2 to have an artificial temporal gap, or artificial arrival times, relative to the direct sound wave front 208. Generally, the temporal gap refers to the interval or space between the arrival of the one or more direct sound wave fronts and the arrival of the one or more indirect sound wave fronts 308.1 and 308.2. In some embodiments, the artificial temporal gap can provide auditory cues to the audience 210 about the size, the shape, and/or the acoustics, among others, of the real-world playback room 202. For example, the audience 210 can perceive the real-world playback room 202 as being the “large” room described herein with an artificial temporal gap between the direct sound wave front 208 and the one or more indirect sound wave fronts 308.1 and 308.2 when compared to the “small room” as described herein. In this example, in the “large” room, the one or more indirect sound wave fronts 308.1 and 308.2 may take longer to reach the audience 210, which creates the impression of a larger or more expansive environment. In this example, in the “small” room, the one or more indirect sound wave fronts 308.1 and 308.2 can reach the audience 210 more quickly, contributing to the perception of a smaller or more intimate environment.

In some embodiments, the playback room controller 204 and/or the loudspeaker array 206.1 can shape the intensities, or amplitudes, of the one or more indirect sound wave fronts 308.1 and 308.2 to reach the audience 210 to have an artificial level gap, or artificial level difference, relative to the direct sound wave front 208. Generally, the level gap, or the level difference, refers to the difference in sound intensity or loudness between the direct sound wave front 208 and the one or more indirect sound wave fronts 308.1 and 308.2. In some embodiments, the artificial level gap can provide auditory cues to the audience 210 about the size, the shape, and/or the acoustics, among others, of the real-world playback room 202. For example, the audience 210 can perceive the real-world playback room 202 as being the “large” room described herein, with an artificial level gap, or artificial level difference, between the direct sound wave front 208 and the one or more indirect sound wave fronts 308.1 and 308.2 when compared to the “small room” as described herein. In this example, in the “large” room, the one or more indirect sound wave fronts 308.1 and 308.2 may be less intense due to the greater distance these sound wave fronts travel before bouncing back to the audience 210 that creates the impression of a larger or more expansive environment. In this example, in the “small” room, the one or more indirect sound wave fronts 308.1 and 308.2 can reach the audience 210 with higher intensity, contributing to the perception of a smaller or more intimate environment.

In some embodiments, the audience 210 can perceive the location of the loudspeaker array 206.1 within the real-world playback room 202 from the middle and/or the high frequency ranges of the direct soundwave 208. However, in these embodiments, the time differences can be too insignificant to derive a directional detection of the loudspeaker array 206.1 at the long wavelengths below about 200 Hertz (Hz). Alternatively, or in addition to, several wavelengths of the direct sound wave front 208 fit between the ears at approximately four (4) kHz, so that the localization of the loudspeaker array 206.1 can become ambiguous. As such, it can be advantageous to align the frequency range from approximately four hundred (400) Hz to approximately four (4) kHz or approximately six (6) kHz with the loudspeaker array 206.1. Below the frequency range of approximately four hundred (400) Hz, the loudspeaker array 206.1 can include a conventional loudspeaker to provide omnidirectional sound radiation. At the upper end of the band, the distance between the individual loudspeaker chassis determines the aliasing frequency above which no controlled radiation is possible. In some embodiments, the distance between the individual loudspeakers in the loudspeaker array 206.1 should not be greater than approximately four (4) centimeters (cm). Usually, such small loudspeakers cannot produce the frequency range below approximately one (1) or approximately two (2) kHz at an adequate level. In some embodiments, the frequency range above the crossover frequency can therefore be split again into different loudspeaker types. In these embodiments, these different loudspeaker types can, for example, be arranged in several layers one behind the other, or have other suitable designs that will be apparent to those skilled in the relevant art(s) without departing from the spirit and scope of the present disclosure. In these embodiments, these different loudspeaker types can be controlled separately in accordance with the wave field synthesis (WFS) capabilities described herein. Alternatively, or in addition to, below the crossover frequency, the loudspeaker array 206.1 can include monophonic amplifiers, for example, if only one, or a small number, of larger loudspeakers is intended for this range. Then the entire frequency range that is particularly important for perception can be easily controlled. In some embodiments, the playback room controller 204 and/or the loudspeaker array 206.1 can shape the middle and/or the high frequency ranges of the direct sound wave front 208 and/or the one or more indirect sound wave fronts 308.1 and 308.2 in accordance with the wave field synthesis (WFS) capabilities described herein. In these embodiments, the playback room controller 204 and/or the loudspeaker array 206.1 can shape the direct soundwave 208 and/or the one or more indirect sound wave fronts 308.1 and 308.2 to create the listening area 212 within the real-world playback room 202 as described herein. Alternatively, or in addition to, the audience 210 can have difficulty in perceiving the location of the loudspeaker array 206.1 within the real-world playback room 202 from the low frequency range of the direct soundwave 208. In some embodiments, the spatial perception of the audio content in the real-world playback room 202 is influenced by, for example, the phase differences between the direct soundwave 208 that determine the position of a phantom source between the loudspeaker array 206.1 and the loudspeaker array 206.2 as described herein. In these embodiments, the playback room controller 204 and/or the loudspeaker array 206.1 can use channel-based audio capabilities and/or point-source audio capabilities to provide the low frequency range of the direct soundwave 208 and/or the one or more indirect sound wave fronts 308.1 and 308.2. Generally, these channel-based audio capabilities and/or point-source audio capabilities provide the low frequency range of the direct sound wave front 208 and/or the one or more indirect sound wave fronts 308.1 and 308.2 without the complex wavefront synthesis employed in the WFS capabilities described herein.

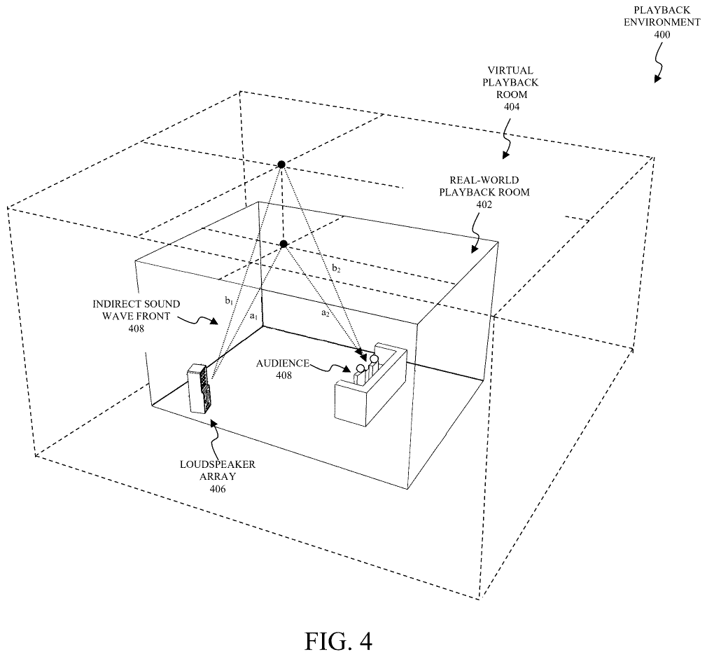

FIG. 4 further illustrates the exemplary one or more indirect sound wave fronts that can be generated within the exemplary playback environment according to some exemplary embodiments of the present disclosure. In the exemplary embodiment illustrated in FIG. 4, a playback environment 400 can enhance the sensory perception of the physical space of a real-world playback room while playing back audiovisual content. In some embodiments, the playback environment 400 can advantageously tailor the audiovisual content to beneficially create an auditory illusion that the real-world playback room is different, for example, larger or smaller, than its actual physical dimensions. In these embodiments, the playback environment 400 can shape one or more indirect sound wave fronts generated within the playback environment 400 to have an artificial temporal gap, or artificial arrival times, relative to one or more direct sound wave fronts, for example, one or more of the direct sound wave front 208, that are generated in the real-world playback room to artificially augment the time difference between these direct and one or more indirect sound wave fronts creating an impression that the real-world playback room is different than its actual physical dimensions. These direct sound wave fronts are not illustrated in FIG. 4 for simplicity. Alternatively, or in addition to, the playback environment 400 can shape the one or more indirect sound wave fronts to have an artificial level gap, or an artificial level difference, relative to the one or more direct sound wave fronts to artificially augment the level difference between these direct and one or more indirect sound wave fronts creating an impression that the real-world playback room is different than its actual physical dimensions. As illustrated in FIG. 4, the playback environment 400 can include a real-world playback room 402 and a virtual playback room 404. The playback environment 400 can represent an exemplary embodiment of the playback environment 100 as described herein.

In the exemplary embodiment illustrated in FIG. 4, the playback room controller 204 can generate precisely controlled one or more indirect sound wave fronts 408 to be provided by a loudspeaker array 406 within the real-world playback room 402 as described herein. As illustrated in FIG. 4, the one or more indirect sound wave fronts 408 represent sound wave fronts that indirectly reach the audience 410 after being reflected by one or more surfaces, for example, walls, ceilings, floors, furniture, or other objects within the real-world playback room 402. These one or more indirect sound wave fronts provide auditory cues to the audience 410 about the size, shape, and/or acoustics, among others, of the real-world playback room 402. In some embodiments, the timing, the intensity, and/or the direction, among others, of the one or more indirect sound wave fronts 408 can advantageously allow the audience 410 to perceive characteristics, for example, objects, boundaries, and/or the overall size, among others, of the real-world playback room 402.

Although the audience 410 is physically present within the real-world playback room 402 as illustrated in FIG. 4, the playback room controller 204 can advantageously customize audio content to create the impression that the audience 410 is listening to the audio content within the virtual playback room 404. In some embodiments, the virtual playback room 404 can be larger than the real-world playback room 402. In these embodiments, the virtual playback room 404 can offer better sound clarity, enhanced reverberation, a richer, more natural listening experience and/or improved frequency response, among others, when compared to the real-world playback room 402. In these embodiments, the frequency response can adjusted to the subjective perception in the virtual playback room 404, in that the comb filtering effects from the superimposition of the direct wavefront with the one or more indirect sound wave fronts 408 in larger rooms occur at lower frequencies and become more narrower-band, as corresponds to the natural reproduction in large rooms. In some embodiments, the real-world playback room 402 often lacks the physical space to allow sound to develop fully, often leading to muddier, distorted, or unbalanced sound when compared to the virtual playback room 404. In some embodiments, the playback room controller 204 can advantageously tailor the playback of audio content to beneficially create the auditory illusion that the audience 410 is within the virtual playback room 404 as opposed to the real-world playback room 402. In these embodiments, the playback room controller 204 can beneficially shape the direct radiated wavefront emanating from each loudspeaker array as well as the one or more indirect sound wave fronts 408 to create the impression that the one or more indirect sound wave fronts 408 reflect off one or more surfaces, for example, walls, ceilings, floors, furniture, or other objects within the virtual playback room 404.

In some embodiments, the playback room controller 204 can shape the one or more indirect sound wave fronts 408 to reach the audience 410 with an artificial temporal gap, or artificial arrival times, relative to the one or more direct sound wave fronts to artificially augment the time difference between the one or more direct sound wave fronts and the one or more indirect sound wave fronts 408. As illustrated in FIG. 4, the playback room controller 204 can shape the one or more indirect sound wave fronts 408 to reach the audience 410 after being reflected by one or more surfaces, for example, walls, ceilings, floors, furniture, or other objects within the real-world playback room 402. In some embodiments, the one or more indirect sound wave fronts 408 travel along a line a₁ from the loudspeaker array 406 to the ceiling of the real-world playback room 402 and from the ceiling of the real-world playback room 402 to the audience 410 along a line a₂. In these embodiments, the total time (t_{total,real}) needed by the time needed by the one or more indirect sound wave fronts 408 to travel from the loudspeaker array 406 to the ceiling of the real-world playback room 402 then to the audience 410 can be approximated as:

$${t}_{TOTAL , r e a l} = \frac{Distance of a 1}{Speed of Sound} + \frac{Distance of a 2}{Speed of Sound} , \qquad ( 3 )$$

wherein the distance a₁ represents the distance from the loudspeaker array 406 to the ceiling of the real-world playback room 402 along the line a₁ expressed in meters (m), the distance a₂ represents the distance from the ceiling of the real-world playback room 402 to the audience 410 along the line a₂ expressed in meters (m), and the speed of sound is approximately 343 meters per second (m/s) around 20° C. but can vary.

In the exemplary embodiment illustrated in FIG. 4, the playback room controller 204 can beneficially shape the one or more indirect sound wave fronts 408 to create the impression that the one or more indirect sound wave fronts 408 reflect off one or more surfaces, for example, walls, ceilings, floors, furniture, or other objects within the virtual playback room 404. In some embodiments, the playback room controller 204 can beneficially shape the one or more indirect sound wave fronts 408 to make it seem that these one or more indirect sound wave fronts travel along a line b₁ from the loudspeaker array 406 to the ceiling of the virtual playback room 404 and from the ceiling of the virtual playback room 404 to the audience 410 along a line b₂. In these embodiments, the total time (t_{TOTAL,virtual}) needed by the time needed by the one or more indirect sound wave fronts 408 to travel from the loudspeaker array 406 to the ceiling of the virtual playback room 404 then to the audience 410 can be approximated as:

$${t}_{TOTAL , virtual} = \frac{Distance of b 1}{Speed of Sound} + \frac{Distance of b 2}{Speed of Sound} , \qquad ( 4 )$$

wherein the distance b₁ represents the distance from the loudspeaker array 406 to the ceiling of the virtual playback room 404 along the line b₁ expressed in meters (m), the distance b₂ represents the distance from the ceiling of the virtual playback room 404 to the audience 410 along the line b₂ expressed in meters (m), and the speed of sound is approximately 343 meters per second (m/s) around 20° C. but can vary. In some embodiments, it can be beneficial for the one or more indirect sound wave fronts 408 to arrive at the audience 210 between approximately five (5) to approximately fifty (50) milliseconds (ms) after the one or more direct wave fronts. In these embodiments, the difference between the line b₁-line b₂ should be not be greater than approximately seventeen (17) meters.

In some embodiments, the virtual playback room 404 can represent a computer generated three-dimensional space having, for example, an acoustically favorable virtual environment. In these embodiments, this computer generated three-dimensional space can represent a model of a real-world three-dimensional space. In some embodiments, the playback room controller 204 can estimate the distance b₁ from the loudspeaker array 406 to the ceiling of the virtual playback room 404 and the distance b₂ from the ceiling of the virtual playback room 404 for different real-world three-dimensional spaces, such as a music real-world venue, for example, a music theater, a music club, and/or a concert hall, a sporting real-world venue, for example, an arena, a convention center, and/or a stadium, and/or any other suitable real-world venue that will be apparent to those skilled in the relevant art(s) without departing the spirit and scope of the present disclosure. For example, the playback room controller 204 can estimate the distance b₁ from the loudspeaker array 406 to the ceiling of the virtual playback room 404 and the distance b₂ from the ceiling of the virtual playback room 404 to the audience 410 from real-world dimensions of various real-world venues, for example, the distance b₁ from the loudspeaker array 406 to the ceiling and the distance b₂ from the ceiling to the audience 410 for Madison Square Garden is between approximately fifteen (15) and approximately twenty four (24) meters, the Beacon Theatre Center is approximately eighteen (18) meters, Radio City Music Hall is approximately twenty four (24) meters, The Forum is between approximately eighteen (18) and approximately twenty one (21) meters, and The Chicago Theatre is approximately eighteen (18) meters. In this example, the playback room controller 204 can utilize these estimates for the distance b₁ and the distance b₂ to beneficially create the auditory illusion that the audible content is being played back in Madison Square Garden, the Beacon Theatre Center, Radio City Music Hall, The Forum, and/or The Chicago Theatre, among others. In some embodiments, the one or more indirect sound wave fronts 408 are associated with the one or more indirect sound wave fronts 408

In the exemplary embodiment illustrated in FIG. 4, the playback room controller 204 can introduce a temporal delay (t_{DELAY}) to the one or more direct sound wave fronts and/or the one or more indirect sound wave fronts 408 by an amount approximately equal to:

$${t}_{DELAY} = {t}_{T O T A L , b} - {t}_{T O T A L , a} . \qquad ( 5 )$$

In some embodiments, this temporal delay artificially augments the time difference between the one or more direct sound wave fronts and the one or more indirect sound wave fronts 408 to beneficially create the auditory illusion that the audible content is being played back from the virtual playback room 404. Although the one or more indirect sound wave fronts 408 are described being reflected by the ceiling of the real-world playback room 402, this for exemplary purposes only and not limiting. Those skilled in the relevant art(s) will recognize that temporal delays for other one or more indirect sound wave fronts that reflect of one or more other surfaces, for example, walls, floors, furniture, or other objects within the real-world playback room 402 may be similarly estimated without departing from the spirit and scope of the present disclosure.

Alternatively, or in addition to, the playback room controller 204 can shape the one or more indirect sound wave fronts 408 to reach the audience 410 with an artificial level gap, or artificial level difference, relative to the one or more direct sound wave fronts (not shown in FIG. 4 for simplicity) to artificially augment the level difference between the one or more direct sound wave fronts and the one or more indirect sound wave fronts 408. As illustrated in FIG. 4, the playback room controller 204 can shape the one or more indirect sound wave fronts 408 to reach the audience 410 after being reflected by one or more surfaces, for example, walls, ceilings, floors, furniture, or other objects within the real-world playback room 402. In some embodiments, the one or more indirect sound wave fronts 408 travel along the line a₁ from the loudspeaker array 406 to the ceiling of the real-world playback room 402 and along the line a₂ from the ceiling of the real-world playback room 402 to the audience 410. In these embodiments, the sound intensity level (Lᵣₑₐₗ) of the one or more indirect soundwaves 408 at the ceiling of the real-world playback room 402 can be approximated as:

$${L}_{real} = - 10 * log ( Distance {a}_{1} + Distance {a}_{2} ) , \qquad ( 3 )$$

and the sound intensity level (Lᵥᵢᵣₜᵤₐₗ) of the one or more indirect soundwaves 408 at the ceiling of the virtual playback room 404 can be approximated as:

$${L}_{virutal} = - 10 * log ( Distance {b}_{1} + Distance {b}_{2} ) , \qquad ( 4 )$$

wherein the distance a₁ represents the distance from the loudspeaker array 406 to the ceiling of the real-world playback room 402 along the line a₁ expressed in meters (m) and the distance b₁ represents the distance from the loudspeaker array 406 to the ceiling of the virtual playback room 404 along the line b₁ expressed in meters (m).

In the exemplary embodiment illustrated in FIG. 4, the playback room controller 204 can introduce a level gap (L_{GAP}) to the one or more direct soundwaves (not shown in FIG. 4 for simplicity) and/or the one or more indirect soundwaves 408 by an amount approximately equal to:

$${L}_{G a p} = - 10 * log \frac{Distance b 1 + b 2}{Distance a 1 + a 2} [ dB ] . \qquad ( 5 )$$

In some embodiments, this level gap artificially augments the level difference (ILD) between the one or more direct soundwaves and the one or more indirect soundwaves 408 to beneficially create the auditory illusion that the audible content is being played back from the virtual playback room 404.

In some embodiments, the playback room controller 204 can introduce a reflection level gap to the indirect sound wave fronts 408 to balance the acoustic properties of the real-world playback room 402 and the acoustic properties of the virtual playback room 404. In these embodiments, the playback room controller 204 can introduce the additional level gap to the indirect sound wave fronts 408 to accommodate for differences between reflective surfaces of the virtual playback room 404 and reflective surfaces of the real playback room 402. In some embodiments, the playback room controller 204 can identify one or more reflection factors for the real-world playback room 402 and one or more reflections factors the virtual playback room 404. In these exemplary embodiments illustrated in FIG. 4, the playback room controller 204 can introduce the reflection level gap (L_{REFLECTION}) to the indirect sound wave fronts 408 by an amount approximately equal to:

$${L}_{REFLECTION} = 10 * log \frac{{r}_{v i r t u a l}}{{r}_{r e a l}} [ dB ] , \qquad ( 6 )$$

wherein rᵥᵢᵣₜᵤₐₗ represents the one or more reflections factors the virtual playback room 404 and rᵣₑₐₗ represents the one or more reflections factors the real-world playback room 402. For example, if a surface in the virtual playback room 404 is sound-reflecting with a reflection factor of 0.9, and the assigned reflection surface in the real-world playback room 402 strongly absorbs sound with a reflection factor of 0.5, the playback room controller 204 can introduce the reflection level gap of approximately 5.1 dB to the indirect sound wave fronts 408.

### Exemplary Operational Control Flow for the Exemplary Playback Environment

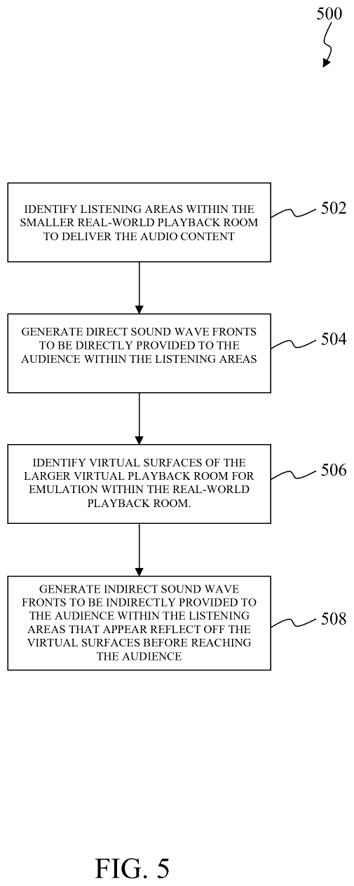

FIG. 5 illustrates an exemplary operational control flow for playing back audiovisual content within the exemplary playback environment according to some exemplary embodiments of the present disclosure. The following discussion is to describe an exemplary operational control flow 500 for enhancing the sensory perception of the physical space of a smaller real-world playback room while playing back audio content. The present disclosure is not limited to these exemplary operational control flows. Rather, it will be apparent to ordinary persons skilled in the relevant art(s) that other operational control flows are within the scope and spirit of the present disclosure. In some embodiments, the operational control flow 500 can be performed by one or more computing systems, such as the playback room controller 204 described herein. Generally, these computing systems, exemplary embodiments of which are to be described in further detail below, can tailor the audio content to create an auditory illusion creating an impression that the audio content is being played back in a different, for example, larger virtual playback room rather than the smaller real-world playback room.

At operation 502, the operational control flow 500 can identify one or more listening areas within the smaller real-world playback room to deliver the audio content. In some embodiments, the operational control flow 500 can determine one or more locations of one or more members of the audience within the smaller real-world playback room. In these embodiments, the operational control flow 500 can utilize using various tracking methods, for example, infrared (IR) tracking, radio frequency (RF) tracking, ultrasonic tracking, camera-based tracking, Wi-Fi tracking, Bluetooth tracking, and/or pressure sensors, among others, to determine the one or more locations of the one or more members of the audience. In some embodiments, the operational control flow 500 can compare the one or more locations of one or more members of the audience with a preset library of listening areas corresponding to the smaller real-world playback room. In these embodiments, the operational control flow 500 can select one or more preset listening areas from among the preset library of listening areas that encompass the one or more members of the audience. In some embodiments, the one or more preset listening areas can define one or more precisely controlled parameters, characteristics, and/or attributes, for example, phases and/or amplitudes, for one or more direct sound wave fronts and/or one or more indirect sound wave fronts to be provided by one or more loudspeaker arrays as described herein to create the one or more preset listening areas within the real-world playback to beneficially provide a localized, high-quality audio experience within the smaller real-world playback room.

At step 504, the operational control flow 500 generates the one or more direct sound wave fronts of the audio content to be directly provided to the audience within the one or more listening areas from step 502. In some embodiments, the operational control flow 500 can precisely control these one or more direct sound wave fronts within the smaller real-world playback room to create the one or more listening areas from step 502. In these embodiments, the operational control flow 500 can precisely control these one or more direct sound wave fronts to prevent these one or more direct sound wave fronts from undesirably interacting with the smaller real-world playback room, for example, reflecting and/or refracting. In some embodiments, the operational control flow 500 can shape the one or more direct sound wave fronts to be perceived, namely, heard, by the audience within the one or more listening areas from step 502. In these embodiments, the playback room controller 204 can shape the one or more direct sound wave fronts in accordance with the wave field synthesis (WFS) capabilities described herein. For example, the operational control flow 500 can shape the direct sound wave fronts in accordance with the one or more precisely controlled parameters, characteristics, and/or attributes from step 502 to create the one or more listening areas from step 502 as described herein.

At step 506, the operational control flow 500 identifies one or more virtual surfaces of the larger virtual playback room, for example, virtual walls, virtual ceilings, virtual floors, virtual furniture, or other virtual objects, for emulation within the real-world playback room. In some embodiments, these one or more surfaces can represent computer-generated models of one or more surfaces of different venues, such as a music real-world venue, for example, a music theater, a music club, and/or a concert hall, a sporting real-world venue, for example, an arena, a convention center, and/or a stadium, and/or any other suitable real-world venue that will be apparent to those skilled in the relevant art(s) without departing the spirit and scope of the present disclosure. For example, these different venues can include well-known venues, such as Madison Square Garden, the Beacon Theatre Center, Radio City Music Hall, The Forum, and/or The Chicago Theatre, among others.

At step 508, the operational control flow 500 generates the one or more indirect sound wave fronts of the audio content to be indirectly provided to the audience within the one or more listening areas from step 502 that appear reflect, or bounce, off the one or more virtual surfaces from step 506 before reaching the audience. In some embodiments, the operational control flow 500 can shape the one or more indirect sound wave fronts to have a longer temporal gap, or longer arrival times, relative to the one or more direct sound wave fronts from step 504 to increase the time difference between the one or more direct sound wave fronts from step 504 and the one or more indirect sound wave fronts. In these embodiments, the operational control flow 500 can introduce a temporal delay to the one or more indirect sound wave fronts as described herein to make it appear that these one or more indirect sound wave fronts reflect, or bounce, off the one or more virtual surfaces of the larger virtual playback room from step 506 before reaching the audience. Alternatively, or in addition to, the operational control flow 500 can shape the one or more indirect sound wave fronts to have a less pronounced level gap, or less pronounced level difference, relative to the one or more direct sound wave fronts from step 504 to increase the level difference between the one or more direct sound wave fronts from step 504 and the one or more indirect sound wave fronts. In the exemplary embodiment illustrated in FIG. 4, the playback room controller can introduce a level gap to the one or more indirect sound wave fronts as described herein to make it appear that these one or more indirect sound wave fronts reflect, or bounce, off the one or more virtual surfaces of the larger virtual playback room from step 506 before reaching the audience.

Exemplary Playback Room Controller that can be Implemented within the Exemplary Playback Environment

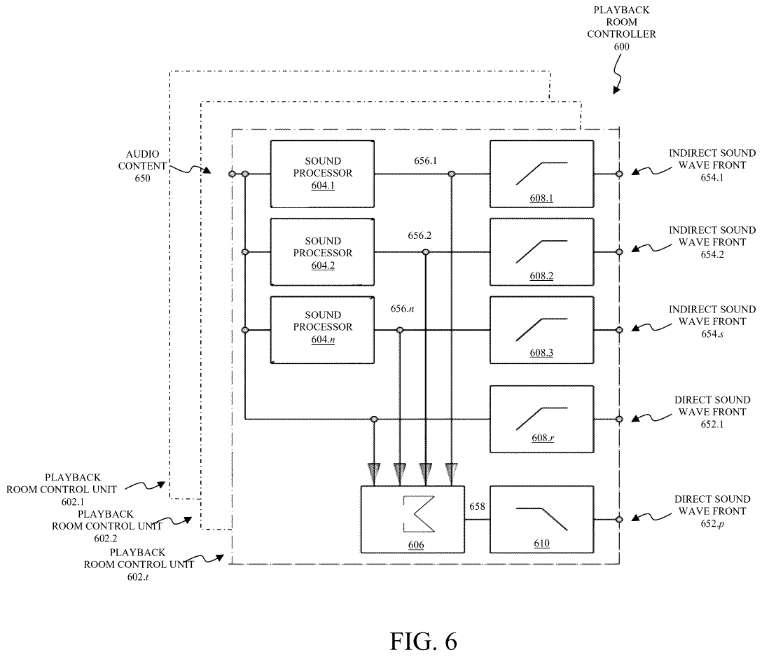

FIG. 6 illustrates a simplified block diagram of an exemplary playback room controller that can be implemented within the exemplary playback environment according to some exemplary embodiments of the present disclosure. In the exemplary embodiment illustrated in FIG. 6, a playback room controller 600 can tailor audio content 650 to create an auditory illusion creating an impression that a real-world playback room is different, for example, larger, than its actual physical dimensions. In these embodiments, the playback room controller 600 can beneficially generate one or more direct sound wave fronts 652.1 through 652.p of the audio content 650 that directly reach an audience within the real-world playback room and/or one or more indirect sound wave fronts 654.1 through 654.s of the audio content 650 that reflect, or bounce, off one or more surfaces of the real-world playback room before reaching the audience. In these embodiments, the playback room controller 600 can advantageously customize the one or more indirect sound wave fronts 654.1 through 654.s to create the impression that the audience is in a larger physical space than the real-world playback room. As illustrated in FIG. 6, the playback room controller 600 can include one or more playback room control units 602.1 through 602.t. In some embodiments, each playback room control unit from among the one or more playback room control units 602.1 through 602.t corresponds to a different audio channel from among multiple audio channels being played within the real-world playback room. For example, the one or more playback room control units 602.1 through 602.t can include two or more playback room control units to playback left stereo channels and right stereo channels or further loudspeaker channels. In the exemplary embodiment illustrated in FIG. 6, each playback room control units from among the one or more playback room control units 602.1 through 602.t is substantially similar to one another. As such, only the playback room control unit 602.1 is to be described in further detail below.

In the exemplary embodiment illustrated in FIG. 6, the playback room control unit 602.1 can generate the one or more direct sound wave fronts 652.1 through 652.p and the one or more indirect sound wave fronts 654.1 through 654.s of the audio content 650 to be played back in the real-world playback to create the impression that the audience is in a larger physical space than the real-world playback room as described herein. As illustrated in FIG. 6, the playback room control unit 602.1 can include sound processors 604.1 through 604.n, an audio mixing unit 606, digital high-pass crossover filters 608.1 through 608.r, and/or a digital low-pass crossover filter 610. In some embodiments, the sound processors 604.1 through 604.n can tailor the audio content 650 to provide corresponding raw, or dry, one or more indirect sound wave fronts from among one or more raw, or dry, one or more indirect sound wave fronts 656.1 through 656.n that, when played back in the real-world playback, can create an auditory illusion creating an impression that a real-world playback room is larger than its actual physical dimensions. In these embodiments, the sound processors 604.1 through 604.n can shape the one or more raw one or more indirect sound wave fronts 656.1 through 656.n to have artificial temporal gaps, or longer arrival times, relative to the one or more direct sound wave fronts 652.1 through 652.p to increase the time difference between these one or more direct sound wave fronts and these one or more indirect sound wave fronts as described herein. In these embodiments, the sound processors 604.1 through 604.n can introduce various temporal delays to the audio content 650 as described herein to make it appear that the one or more indirect sound wave fronts 654.1 through 654.s reflect, or bounce, off the one or more virtual surfaces of the virtual playback room before reaching the audience as described herein. Alternatively, or in addition to, the operational control flow 500 can shape the one or more raw one or more indirect sound wave fronts 656.1 through 656.n to have an artificial level gap, or artificial level difference, relative to the one or more direct sound wave fronts 652.1 through 652.p to increase the level difference between these one or more direct sound wave fronts and these one or more indirect sound wave fronts as described herein. In these embodiments, the sound processors 604.1 through 604.n can introduce a level gap to the audio content 650 as described herein to make it appear that the one or more indirect sound wave fronts 654.1 through 654.s reflect, or bounce, off the one or more virtual surfaces of the virtual playback room before reaching the audience as described herein.

In some embodiments, the audience can perceive the location of various loudspeaker arrays within the real-world playback room from the middle and/or the high frequency ranges of the one or more direct sound wave fronts 652.1 through 652.p and/or the one or more indirect sound wave fronts 654.1 through 654.s as described herein. Alternatively, or in addition to, the audience can have difficulty in perceiving the location of the various loudspeaker arrays within the real-world playback room from the low frequency range of the one or more direct sound wave fronts 652.1 through 652.p. In the exemplary embodiment illustrated in FIG. 6, the audio mixing unit 606 can combine the audio content 650 and the one or more raw one or more indirect sound wave fronts 656.1 through 656.n to provide the one or more raw one or more direct sound wave fronts 658. In some embodiments, the digital high-pass crossover filters 608.1 through 608.3 from among the digital high-pass crossover filters 608.1 through 608.r can process the one or more raw one or more indirect sound wave fronts 656.1 through 656.n to suppress the low frequency range of the one or more raw one or more indirect sound wave fronts 656.1 through 656.n, for example, those below the crossover frequency, to provide the one or more indirect sound wave fronts 654.1 through 654.s. In these embodiments, the one or more indirect sound wave fronts 654.1 through 654.s can be characterized as including the middle and/or the high frequency ranges of the one or more raw one or more indirect sound wave fronts 656.1 through 656.n. In some embodiments, the digital high-pass crossover filter 608.r from among the digital high-pass crossover filters 608.1 through 608.r can similarly process the audio content 650 to suppress the low frequency range of the audio content 650, for example, those below the crossover frequency, to provide the one or more direct sound wave fronts 652.1 from among the one or more direct sound wave fronts 652.1 through 652.p. In these embodiments, the one or more direct sound wave fronts 652.1 can be characterized as including the middle and/or the high frequency ranges of the audio content 650. In some embodiments, the digital low-pass crossover filter 610 can process the one or more raw one or more direct sound wave fronts 658 to suppress the middle and/or the high frequency ranges of the one or more raw one or more direct sound wave fronts 658, for example, those above the crossover frequency, to provide the one or more direct sound wave fronts 652.p from among the one or more direct sound wave fronts 652.1 through 652.p. In these embodiments, the one or more direct sound wave fronts 652.p can be characterized as including the low frequency ranges of the one or more raw one or more direct sound wave fronts 658.

Exemplary Computer System that can be Implemented within the Exemplary Playback Environment

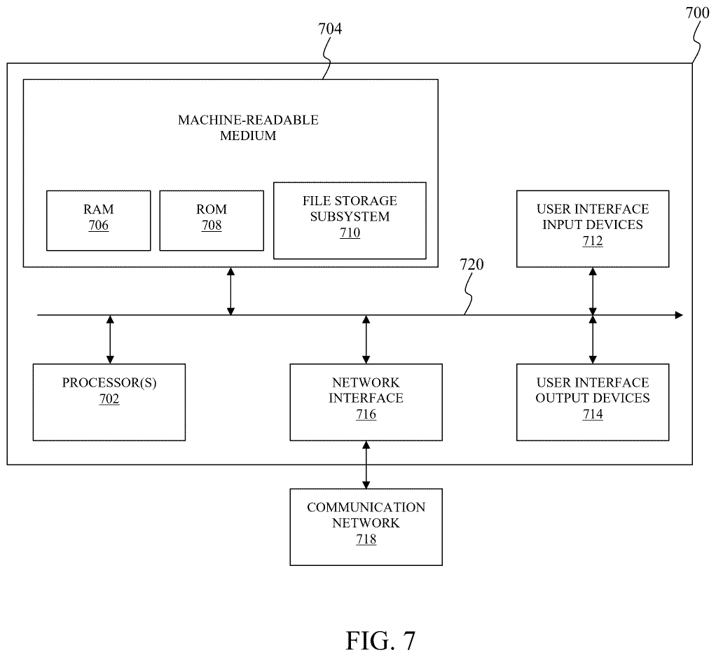

FIG. 7 illustrates a simplified block diagram of an exemplary computer system that can be implemented within the exemplary playback environment according to some exemplary embodiments of the present disclosure. The discussion of FIG. 7 to follow is to describe a computer system 700 that can be used to implement the playback room controller 204 as described above.

In the exemplary embodiment illustrated in FIG. 7, the computer system 700 includes one or more processors 702. In some embodiments, the one or more processors 702 can include, or can be, any of a microprocessor, graphics processing unit, or digital signal processor, and their electronic processing equivalents, such as an Application Specific Integrated Circuit (“ASIC”) or Field Programmable Gate Array (“FPGA”). As used herein, the term “processor” signifies a tangible data and information processing device that physically transforms data and information, typically using a sequence transformation (also referred to as “operations”). Data and information can be physically represented by an electrical, magnetic, optical or acoustical signal that is capable of being stored, accessed, transferred, combined, compared, or otherwise manipulated by the processor. The term “processor” can signify a singular processor and multi-core systems or multi-processor arrays, including graphic processing units, digital signal processors, digital processors or combinations of these elements. The processor can be electronic, for example, comprising digital logic circuitry (for example, binary logic), or analog (for example, an operational amplifier). The processor may also operate to support performance of the relevant operations in a “cloud computing” environment or as a “software as a service” (SaaS). For example, at least some of the operations may be performed by a group of processors available at a distributed or remote system, these processors accessible via a communications network (e.g., the Internet) and via one or more software interfaces (e.g., an application program interface (API).) In some embodiments, the computer system 700 can include an operating system, such as Microsoft's Windows, Sun Microsystems's Solaris, Apple Computer's MacOs, Linux or UNIX. In some embodiments, the computer system 700 can also include a Basic Input/Output System (BIOS) and processor firmware. The operating system, BIOS and firmware are used by the one or more processors 702 to control subsystems and interfaces coupled to the one or more processors 702. In some embodiments, the one or more processors 702 can include the Pentium and Itanium from Intel, the Opteron and Athlon from Advanced Micro Devices, and the ARM processor from ARM Holdings.

As illustrated in FIG. 7, the computer system 700 can include a machine-readable medium 704. In some embodiments, the machine-readable medium 704 can further include a main random-access memory (“RAM”) 706, a read only memory (“ROM”) 708, and/or a file storage subsystem 710. The RAM 730 can store instructions and data during program execution and the ROM 732 can store fixed instructions. The file storage subsystem 710 provides persistent storage for program and data files, and may include a hard disk drive, a floppy disk drive and associated removable media, a CD-ROM drive, an optical drive, a flash memory, or removable media cartridges.

The computer system 700 can further include user interface input devices 712 and user interface output devices 714. The user interface input devices 712 can include an alphanumeric keyboard, a keypad, pointing devices such as a mouse, trackball, touchpad, stylus, or graphics tablet, a scanner, a touchscreen incorporated into the display, audio input devices such as voice recognition systems or microphones, eye-gaze recognition, brainwave pattern recognition, and other types of input devices to provide some examples. The user interface input devices 712 can be connected by wire or wirelessly to the computer system 700. Generally, the user interface input devices 712 are intended to include all possible types of devices and ways to input information into the computer system 700. The user interface input devices 712 typically allow a user to identify objects, icons, text and the like that appear on some types of user interface output devices, for example, a display subsystem. The user interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other device for creating a visible image such as a virtual reality system. The display subsystem may also provide non-visual display such as via audio output or tactile output (e.g., vibrations) devices. Generally, the user interface output devices 720 are intended to include all possible types of devices and ways to output information from the computer system 700.

The computer system 700 can further include a network interface 716 to provide an interface to outside networks, including an interface to a communication network 718, and is coupled via the communication network 718 to corresponding interface devices in other computer systems or machines. The communication network 718 may comprise many interconnected computer systems, machines and communication links. These communication links may be wired links, optical links, wireless links, or any other devices for communication of information. The communication network 718 can be any suitable computer network, for example a wide area network such as the Internet, and/or a local area network such as Ethernet. The communication network 718 can be wired and/or wireless, and the communication network can use encryption and decryption methods, such as is available with a virtual private network. The communication network uses one or more communications interfaces, which can receive data from, and transmit data to, other systems. Embodiments of communications interfaces typically include an Ethernet card, a modem (e.g., telephone, satellite, cable, or ISDN), (asynchronous) digital subscriber line (DSL) unit, Firewire interface, USB interface, and the like. One or more communications protocols can be used, such as HTTP, TCP/IP, RTP/RTSP, IPX and/or UDP.

As illustrated in FIG. 7, the one or more processors 702, the machine-readable medium 704, the user interface input devices 712, the user interface output devices 714, and/or the network interface 716 can be communicatively coupled to one another using a bus subsystem 720. Although the bus subsystem 720 is shown schematically as a single bus, alternative embodiments of the bus subsystem may use multiple buses. For example, RAM-based main memory can communicate directly with file storage systems using Direct Memory Access (“DMA”) systems.

### CONCLUSION

Although the Detailed Description has been described in terms of creating the impression that the audience is in a larger physical space than the real-world playback room herein, this is for exemplary purposes only. Those skilled in the relevant art(s) can readily modify and/or adapt the Detailed Description, without undue experimentation, to similarly create the impression that the audience is in a smaller physical space than the real-world playback room without departing from the spirit and scope of the disclosure. On the other hand, for example, simpler versions of the invention, which are not explicitly adapted to the real-world playback room 402, but in which generalized values, for example for a right and left placement of the loudspeaker arrays 206.1 and 206.2 in an average-sized reproduction room, are pre-programmed, can significantly improve the perception of the audio content compared to conventional loudspeakers.

The Detailed Description referred to accompanying figures to illustrate exemplary embodiments consistent with the disclosure. References in the disclosure to “an exemplary embodiment” indicates that the exemplary embodiment described can include a particular feature, structure, or characteristic, but every exemplary embodiment may not necessarily include the particular feature, structure, or characteristic. Moreover, such phrases are not necessarily referring to the same exemplary embodiment. Further, any feature, structure, or characteristic described in connection with an exemplary embodiment can be included, independently or in any combination, with features, structures, or characteristics of other exemplary embodiments whether or not explicitly described.

The Detailed Description is not meant to be limiting. Rather, the scope of the disclosure is defined only in accordance with the following claims and their equivalents. It is to be appreciated that the Detailed Description section, and not the Abstract section, is intended to be used to interpret the claims. The Abstract section can set forth one or more, but not all exemplary embodiments, of the disclosure, and thus, are not intended to limit the disclosure and the following claims and their equivalents in any way.

The exemplary embodiments described within the disclosure have been provided for illustrative purposes and are not intended to be limiting. Other exemplary embodiments are possible, and modifications can be made to the exemplary embodiments while remaining within the spirit and scope of the disclosure. The disclosure has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

Embodiments of the disclosure can be implemented in hardware, firmware, software application, or any combination thereof. Embodiments of the disclosure can also be implemented as instructions stored on a machine-readable medium, which can be read and executed by processors. A machine-readable medium can include any mechanism for storing or transmitting information in a form readable by a machine (e.g., a computing circuitry). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software application, routines, instructions can be described herein as performing certain actions. However, it should be appreciated that such descriptions are merely for convenience and that such actions in fact result from computing devices, processors, controllers, or other devices executing the firmware, software application, routines, instructions, etc.

The Detailed Description of the exemplary embodiments fully revealed the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

What is claimed is:

1. A method for playing back audio content within a real-world playback room, the method comprising:
identifying, by a playback room controller, a listening area within the real-world playback room to deliver the audio content;
generating, by the playback room controller, a direct soundwave of the audio content to be directly provided to the audience within the listening area;
identifying, by the playback room controller, a virtual surface of a virtual playback room for emulation within the real-world playback room; and
generating, by the playback room controller, an indirect soundwave of the audio content to be indirectly provided to the audience within the listening area that appears reflect off the virtual surface of the virtual playback room before reaching the audience.

2. The method of claim 1, wherein the identifying comprises:
determining a location of the audience within the real-world playback room;
comparing the location of the audience with a preset library of listening areas corresponding to the real-world playback room; and
selecting a preset listening area from among the preset library of listening areas that encompasses the audience.

3. The method of claim 1, wherein the generating the direct soundwave of the audio content comprises shaping the direct soundwave in accordance one or more precisely controlled parameters, characteristics, or attributes that are associated with the listening area to create the listening area with wave field synthesis (WFS) capabilities.

4. The method of claim 3, wherein the generating the direct soundwave of the audio content comprises controlling the direct soundwave to be heard by the audience with the real-world playback room to prevent the direct soundwave from undesirably interacting with the real-world playback room.

5. The method of claim 1, wherein the virtual surface of the virtual playback room comprises a virtual wall, a virtual ceiling, a virtual floors, a virtual furniture, or a virtual object that is associated with the virtual playback room.

6. The method of claim 1, wherein the generating the indirect soundwave of the audio content comprises shaping the indirect soundwave to have a longer temporal gap to increase a time difference between the direct soundwave and the indirect sound wave fronts or a more appropriate level gap relative to the one or more direct sound wave fronts to correct a level difference between the direct soundwave and the indirect soundwave to make it appear that the indirect soundwave appears to reflect off the virtual surface of the virtual playback room before reaching the audience.

7. The method of claim 6, wherein the generating the indirect soundwave of the audio content comprises introducing a temporal delay to the indirect soundwave to increase the time difference to make it appear that the indirect soundwave appears to reflect off the virtual surface of the virtual playback room before reaching the audience.

8. A playback room controller for playing back audio content within a real-world playback room, the playback room controller comprising:
a memory that stores instructions; and
a processor configured to execute the instructions, the instructions, when executed by the processor, configuring the processor to:
identify a listening area within the real-world playback room to deliver the audio content,
generate a direct soundwave of the audio content to be directly provided to the audience within the listening area,
identify a virtual surface of a virtual playback room for emulation within the real-world playback room, and
generate an indirect soundwave of the audio content to be indirectly provided to the audience within the listening area that appears reflect off the virtual surface of the virtual playback room before reaching the audience.

9. The playback room controller of claim 8, wherein the instructions, when executed by the processor, configure the processor to:
determine a location of the audience within the real-world playback room;
compare the location of the audience with a preset library of listening areas corresponding to the real-world playback room; and
select a preset listening area from among the preset library of listening areas that encompasses the audience.

10. The playback room controller of claim 8, wherein the instructions, when executed by the processor, configure the processor to shape the direct soundwave in accordance one or more precisely controlled parameters, characteristics, or attributes that are associated with the listening area to create the listening area with wave field synthesis (WFS) capabilities.

11. The playback room controller of claim 10, wherein the instructions, when executed by the processor, configure the processor to control the direct soundwave to be heard by the audience with the real-world playback room to prevent the direct soundwave from undesirably interacting with the real-world playback room.

12. The playback room controller of claim 8, wherein the virtual surface of the virtual playback room comprises a virtual wall, a virtual ceiling, a virtual floors, a virtual furniture, or a virtual object that is associated with the virtual playback room.

13. The playback room controller of claim 8, wherein the instructions, when executed by the processor, configure the processor to shape the indirect soundwave to have a longer temporal gap to increase a time difference between or a more pronounced level gap relative to the one or more direct sound wave fronts to increase a level difference between the direct soundwave and the indirect soundwave to make it appear that the indirect soundwave appears to reflect off the virtual surface of the virtual playback room before reaching the audience.

14. The playback room controller of claim 13, wherein the instructions, when executed by the processor, configure the processor to introduce a temporal delay to the indirect soundwave to increase the time difference to make it appear that the indirect soundwave appears to reflect off the virtual surface of the virtual playback room.

15. A playback room system for playing back audio content within a real-world playback room, the playback room system comprising:
a playback room controller configured to:
identify a listening area within the real-world playback room to deliver the audio content,
generate a direct soundwave of the audio content to be directly provided to the audience within the listening area,
identify a virtual surface of a virtual playback room for emulation within the real-world playback room, and
generate one or more indirect sound wave fronts of the audio content to be indirectly provided to the audience within the listening area that appears reflect off the virtual surfaces of the virtual playback room before reaching the audience; and
a loudspeaker array configured to playback the direct soundwave of the audio and the in direct soundwave of the audio content to the audience within the listening area.

16. The playback room system of claim 15, wherein the processor is configured to:
determine a location of the audience within the real-world playback room;
compare the location of the audience with a preset library of listening areas corresponding to the real-world playback room; and
select a preset listening area from among the preset library of listening areas that encompasses the audience.

17. The playback room system of claim 15, wherein the processor is configured to shape the direct soundwave in accordance one or more precisely controlled parameters, characteristics, or attributes that are associated with the listening area to create the listening area with wave field synthesis (WFS) capabilities.

18. The playback room system of claim 17, wherein the processor is configured to control the direct soundwave to be heard by the audience with the real-world playback room to prevent the direct soundwave from undesirably interacting with the real-world playback room.

19. The playback room system of claim 15, wherein the processor is configured to shape the indirect soundwave to have a longer temporal gap to increase a time difference between or a more appropriate level gap relative to the one or more direct sound wave fronts to increase a level difference between the direct soundwave and the indirect soundwave to make it appear that the indirect soundwave appears to reflect off the virtual surface of the virtual playback room before reaching the audience.

20. The playback room system of claim 19, wherein the processor is configured to introduce a temporal delay to the indirect soundwave to increase the time difference to make it appear that the indirect soundwave appears to reflect off the virtual surface of the virtual playback room.
